(19) United States
(12) Patent Application Publication
(10) Pub. No.: US 2023/0395942 A1
(43) Pub. Date: Dec. 7, 2023

(54) BATTERY

(71) Applicant: Panasonic Intellectual Property Management Co., Ltd., Osaka (JP)

(72) Inventors: Eiichi KOGA, Osaka (JP); Noriyuki UCHIDA, Osaka (JP)

(21) Appl. No.: 18/447,901

(22) Filed: Aug. 10, 2023

Related U.S. Application Data
(63) Continuation of application No. PCT/JP2021/044534, filed on Dec. 3, 2021.

(30) Foreign Application Priority Data
Feb. 19, 2021 (JP) 2021-025663

(51) Int. Cl. H01M 50/474; H01M 50/533; H01M 50/186; H01M 50/105; H01M 50/486; H01M 50/121

(52) U.S. Cl. CPC H01M 50/474; H01M 50/533; H01M 50/121; H01M 50/105; H01M 50/486; H01M 50/186

(57) ABSTRACT

A battery of the present disclosure includes: a battery element, the battery element including a first electrode, a solid electrolyte layer, and a second electrode; a first insulating member; a second insulating member; and a void. The battery element has a laminated structure in which the first electrode, the solid electrolyte layer, and the second electrode are disposed in this order. The first insulating member coats at least a portion of a side surface of the battery element, the second insulating member encloses the battery element, the first insulating member, and the void, and the void includes a void positioned close to the side surface of the battery element.

This application is a continuation of PCT/JP2021/044534 filed on Dec. 3, 2021, which claims foreign priority of Japanese Patent Application No. 2021-025663 filed on Feb. 19, 2021, the entire contents of both of which are incorporated herein by reference.

### BACKGROUND OF THE INVENTION

### 1. Field of the Invention

The present disclosure relates to a battery.

### 2. Description of Related Art

Miniature surface-mounted batteries having excellent safety have been desired in recent years. JP 2020-009596 A discloses an all-solid-state battery in which a power generation element is housed in a laminated exterior body to suppress water penetration into the power generation element. JP 2014-195052 A discloses a surface-mounted electrochemical cell in which an electrolyte solution and a power generation element are housed in a hermetically sealed space.

### SUMMARY OF THE INVENTION

The present disclosure aims to enhance the reliability of a battery.

A battery of the present disclosure including:
a battery element, the battery element including a first electrode, a solid electrolyte layer, and a second electrode;
a first insulating member;
a second insulating member; and
a void, wherein
the battery element has a laminated structure in which the first electrode, the solid electrolyte layer, and the second electrode are disposed in this order,
the first insulating member coats at least a portion of a side surface of the battery element,
the second insulating member encloses the battery element, the first insulating member, and the void, and
the void includes a void positioned close to the side surface of the battery element.

The present disclosure can enhance the reliability of a battery.

### BRIEF DESCRIPTION OF THE DRAWINGS

FIG. 1 schematically shows the configuration of a battery 1100 according to Embodiment 1.

FIG. 2 schematically shows the configuration of a battery 1200 according to Embodiment 2.

FIG. 3 schematically shows the configuration of a battery 1300 according to Embodiment 3.

FIG. 4 schematically shows the configuration of a battery 1400 according to Embodiment 4.

FIG. 5 schematically shows the configuration of a battery 1500 according to Embodiment 5.

FIG. 6 schematically shows the configuration of a battery 1600 according to Embodiment 6.

### DETAILED DESCRIPTION

Embodiments of the present disclosure will be specifically described below with reference to the drawings.

The embodiments to be described below each illustrate a generic or specific example. The numerical values, shapes, materials, constituent elements, arrangement positions of the constituent elements, and manners of connection of the constituent elements, etc. which will be indicated in the embodiments below are only illustrative, and are not intended to limit the present disclosure.

In the present specification, terms such as parallel representing the relations between elements, terms such as rectangular parallelepiped representing the shapes of elements, and numerical ranges are not expressions representing only their strict meanings, but are intended to include even substantial equivalents, for example, even variations of about several percentage.

The drawings are not necessarily strict. In the drawings, substantially identical constituent elements are assigned with the same reference numerals, and redundant description thereof will be omitted or simplified.

In the present specification and drawings, the x axis, the y axis, and the z axis indicate the three axes in a three-dimensional orthogonal coordinate system. In the embodiments, the z-axis direction is defined as the thickness direction of the battery. Moreover, in the present specification, the “thickness direction” refers to a direction perpendicular to the plane up to which the layers are laminated in the battery element, unless specifically stated otherwise.

In the present specification, the phrase “in plan view (or simply “plan”)” means that the battery is viewed along the lamination direction in the battery element, unless specifically stated otherwise. In the present specification, the “thickness” refers to the length of the battery element and the layers in the lamination direction, unless specifically stated otherwise.

In the present specification, the “side surface” and the “principal surface” of the battery element respectively refer to the surface along the lamination direction and the surface other than the side surface, unless specifically stated otherwise.

In the present specification, “in” and “out” in the terms “inward”, “outward”, and the like respectively indicate the side close to the center of the battery and the side close to the periphery of the battery when the battery is viewed along the lamination direction in the battery element.

In the present specification, the terms “upper” and “lower” in the battery configuration respectively do not mean being in the upward direction (vertically above) and being in the downward direction (vertically below) in the absolute spatial recognition, but are used as the terms defined by the relative positional relation based on the lamination order in the lamination structure. Moreover, the terms “upper” and “lower” are applied not only in the case where two constituent elements are disposed in close and direct contact with each other, but also in the case where two constituent elements are disposed with a space therebetween and other constituent element is present between the two constituent elements.

### Embodiment 1

A battery according to Embodiment 1 includes: a battery element, the battery element including a first electrode, a solid electrolyte layer, and a second electrode; a first insulating member; a second insulating member; and a void. The battery element has a laminated structure in which the first electrode, the solid electrolyte layer, and the second electrode are disposed in this order. The first insulating member coats at least a portion of the side surface of the battery element. The second insulating member encloses the battery element, the first insulating member, and the void. The void includes a void positioned close to the side surface of the battery element.

As described in 2. Description of Related Art, JP 2020-009596 A discloses an all-solid-state battery in which a power generation element is housed in a laminated exterior body to suppress water penetration into the power generation element. In the all-solid-state battery described in JP 2020-009596 A, the power generation element is housed in a laminated sheet in the form of a bag as the exterior body, and the laminated sheet is closed by suction. Accordingly, the laminated exterior body is in contact with the constituent members such as the power generation element with no void between the laminated exterior body and the constituent members, although the laminated exterior body is not fixed to the power generation element. Consequently, a shift of the laminated exterior body or the current collector tab due to vibration or impact tends to cause a short circuit of or damage to the power generation element. Moreover, when the power generation element becomes shifted as above, a gap serving as the moisture penetration path may be generated between the laminated exterior body and the power generation element, although a waterproof material is provided. This leads to a problem in which a short circuit and characteristics degradation are caused by repetition of charge and discharge, the thermal cycle, or impact. JP 2014-195052 A discloses a surface-mounted electrochemical cell including a hermetically-sealing member and a power generation element, where an internal space is provided between the hermetically-sealing member and the power generation element, and the power generation element is impregnated with an electrolyte solution in the internal space. In the surface-mounted electrochemical cell described in JP 2014-195052 A, the power generation element in the electrolyte solution and the hermetically-sealing member are not fixed to each other. Consequently, a shift of the power generation element due to vibration or impact tends to cause a short circuit or damage. Furthermore, in the battery described in JP 2014-195052 A, while the inner side surface of the hermetically-sealing member is coated with an insulator, the side surface of the power generation element is coated with nothing. This tends to cause fall-off of the active material powder (so-called powder fall) from the surface due to impact or the like, and thus tends to cause a short circuit and characteristics degradation.

In the battery according to Embodiment 1, since the second insulating member encloses the battery element, it is possible to reduce the influence on the battery element due to impact from the outside. Moreover, since the battery includes a void and the void includes a void positioned close to the side surface of the battery element, the void can absorb the stress on the second insulating member generated by expansion and contraction of the battery element resulting from charge and discharge. Therefore, it is possible to maintain the sealing properties of the battery, thereby enhancing the reliability. Moreover, since the first insulating member coats at least a portion of the side surface of the battery element, it is possible to suppress collapse of the electrode (powder fall), for example, fall-off of the active material powder from the side surface of the battery element. Therefore, characteristics degradation and a short circuit of the battery can be suppressed, and the reliability can be enhanced.

Here, the void positioned close to the side surface of the battery element refers to a void present at a position overlapping with the side surface of the battery element when the battery according to Embodiment 1 is viewed from the side surface. The void positioned close to the side surface of the battery element is, for example, a void present in a region along the side surface of the battery element, a void present in a region within ½ of the distance between the side surface of the battery element and the side surface of the battery according to Embodiment 1 in the direction from the side surface of the battery element toward the outside of the battery, or a void present in a region within 590 μm or within 500 μm in the direction from the side surface of the battery element toward the outside of the battery.

The battery according to Embodiment 1 may further include a lead terminal connected to the first electrode or the second electrode. The battery according to Embodiment 1 includes, for example, a lead terminal connected to the first electrode and a lead terminal connected to the second electrode.

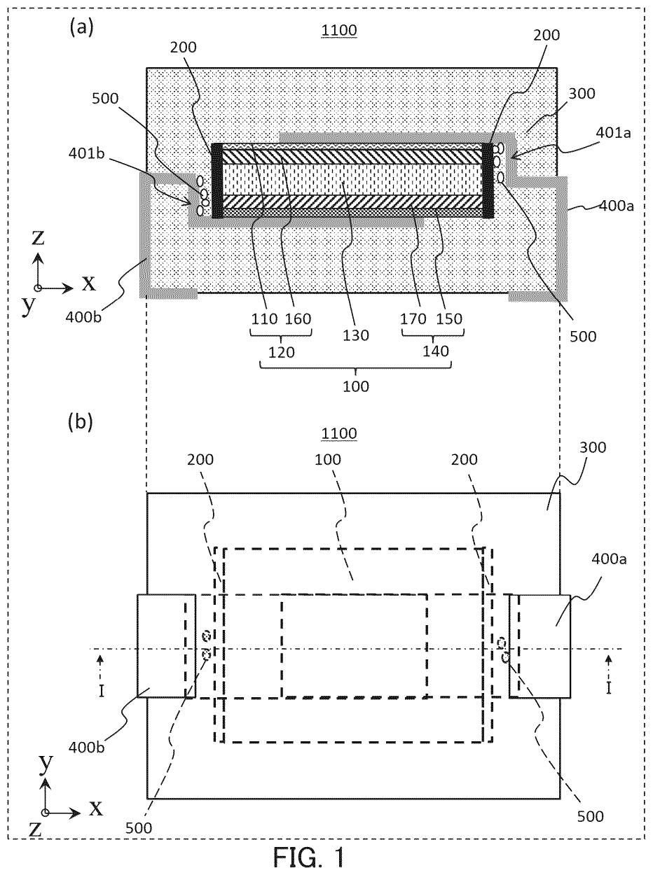

FIG. 1 schematically shows the configuration of a battery 1100 according to Embodiment 1. FIG. 1(a) is a schematic cross-sectional view showing the configuration of the battery 1100 according to Embodiment 1 as viewed in the y-axis direction. FIG. 1(b) is a schematic plan view showing the configuration of the battery 1100 according to Embodiment 1 as viewed from below in the z-axis direction. In FIG. 1(a), a cross section at the position indicated by line I-I in FIG. 1(b) is shown.

As shown in FIG. 1, the battery 1100 includes: a battery element 100, the battery element 100 including a first electrode 120, a solid electrolyte layer 130, and a second electrode 140; a first insulating member 200; a second insulating member 300; and a void 500. The first insulating member 200 coats at least a portion of the side surface of the battery element 100. The second insulating member 300 encloses the battery element 100, the first insulating member 200, and the void 500. The first electrode 120 includes a first current collector 110 and a first active material layer 160. The second electrode 140 includes a second current collector 150 and a second active material layer 170. The battery 1100 further includes a lead terminal 400a electrically connected to the first current collector 110 and a lead terminal 400b electrically connected to the second current collector 150. The lead terminal 400a and the lead terminal 400b are also hereinafter collectively referred to as a lead terminal 400.

In the battery 1100 shown in FIG. 1, the second insulating member 300 encloses the battery element 100, the first insulating member 200, a portion of the lead terminal 400 excluding a portion serving as a mounting terminal portion, and the void 500. That is, the second insulating member 300 is, for example, an exterior body. The excluded portion of the lead terminal 400 is exposed from the second insulating member 300 to be connected, as the mounting terminal portion, to an external circuit.

The void 500 includes a void positioned close to the side surface of the battery element 100. In FIG. 1, an example of the battery 1100 is shown in which the void 500 is positioned close to the side surface of the battery element 100, where the side surface is coated with the first insulating member 200. As shown in FIG. 1, every void 500 may be positioned close to the side surface of the battery element 100. The void 500 may face the side surface of the battery element 100, and may face the first insulating member 200.

In the case where the void 500 is positioned close to the side surface of the battery element 100, the void 500 can further absorb expansion and contraction of the battery element 100 resulting from charge and discharge. Therefore, the reliability of the battery can be enhanced.

The battery 1100 is, for example, an all-solid-state battery.

The constituent elements of the battery 1100 will be described below in detail with reference to FIG. 1.

### (Battery Element 100)

The battery element 100 has a laminated structure in which the first electrode 120, the solid electrolyte layer 130, and the second electrode 140 are disposed in this order. The first electrode 120 includes, for example, the first active material layer 160 and the first current collector 110. The second electrode 140 includes, for example, the second current collector 150 and the second active material layer 170. That is, the battery element 100 has a laminated structure in which, for example, the first current collector 110, the first active material layer 160, the solid electrolyte layer 130, the second active material layer 170, and the second current collector 150 are disposed in this order.

The battery element 100 has a principal surface and the side surface.

At least a portion of the side surface of the battery element 100 is coated with the first insulating member 200.

The principal surface and the side surface of the battery element 100 may be at least partially coated with the second insulating member 300. For example, half or more of the range of both the principal surface and the side surface of the battery element 100 may be coated with the second insulating member 300.

The battery element 100 may be in the shape of a rectangular parallelepiped, or may have a different shape. The different shape of the battery element 100 is, for example, a circular column or a polygonal column. The battery element 100 may be in the shape of a plate.

In the present specification, being in the shape of a rectangular parallelepiped means being roughly in the shape of a rectangular parallelepiped, and includes the concept of being in the shape of a chamfered rectangular parallelepiped. The same applies to other shape expressions in the present specification.

The short side surface of the battery element 100 may be coated with the first insulating member 200. The long side surface of the battery element 100 may be coated with the first insulating member 200. The entire side surface of the battery element 100 may be coated with the first insulating member 200.

In the first electrode 120, other layer such as a joining layer formed of an electrically conductive material may be provided between the first current collector 110 and the first active material layer 160.

In the second electrode 140, other layer such as a joining layer formed of an electrically conductive material may be provided between the second current collector 150 and the second active material layer 170.

The first electrode 120 may be a positive electrode. In this case, the first active material layer 160 is a positive electrode active material layer.

The second electrode 140 may be a negative electrode. In this case, the second active material layer 170 is a negative electrode active material layer.

The first electrode 120 and the second electrode 140 are also hereinafter referred to simply as “electrodes”. Moreover, the first current collector 110 and the second current collector 150 are also referred to simply as “current collectors”.

The positive electrode active material layer contains a positive electrode active material. The positive electrode active material refers to a material that intercalates or deintercalates metal ions, such as lithium (Li) ions or magnesium (Mg) ions, in a crystal structure at a higher potential than the potential of the negative electrode and is accordingly oxidized or reduced. The positive electrode active material can be selected as appropriate depending on the battery type, and a known positive electrode active material can be used. In the case where the battery element 100 is, for example, a lithium secondary battery, the positive electrode active material is a material that intercalates or deintercalates lithium (Li) ions and is accordingly oxidized or reduced. In this case, the positive electrode active material is, for example, a compound containing lithium and a transition metal element, more specifically, an oxide containing lithium and a transition metal element, a phosphate compound containing lithium and a transition metal element, or the like. Examples of the oxide containing lithium and a transition metal element include a lithium nickel composite oxide such as LiNiₓM₁₋ₓO₂ (where M is at least one selected from the group consisting of Co, Al, Mn, V, Cr, Mg, Ca, Ti, Zr, Nb, Mo, and W, and x satisfies 0<x≤1), a layered oxide, such as lithium cobalt oxide (LiCoO₂), lithium nickel oxide (LiNiO₂), and lithium manganese oxide (LiMn₂O₄), and lithium manganese oxide (LiMn₂O₄, Li₂MnO₃, and LiMO₂) having a spinel structure. Examples of the phosphate compound containing lithium and a transition metal element include lithium iron phosphate (LiFePO₄) having an olivine structure. Moreover, sulfur (S) or a sulfide such as lithium sulfide (Li₂S) can also be used for the positive electrode active material. In this case, positive electrode active material particles which are coated with lithium niobate (LiNbO₃) or the like or to which lithium niobate (LiNbO₃) or the like is added can be used as the positive electrode active material. The positive electrode active material may be only one of these materials or a combination of two or more of the materials.

The positive electrode active material layer, which contains the positive electrode active material, may contain a different additive material. That is, the positive electrode active material layer may be a mixture layer. The additive material can be, for example, a solid electrolyte, such as a solid inorganic electrolyte or a solid sulfide electrolyte, an electrically conductive additive such as acetylene black, or a binder, such as polyethylene oxide or polyvinylidene fluoride. By mixing the positive electrode active material with the different additive material, such as a solid electrolyte or an electrically conductive additive, in a predetermined proportion, it is possible to enhance the ionic conductivity inside the positive electrode and enhance the electron conductivity inside the positive electrode as well. The solid electrolyte can be, for example, a solid electrolyte exemplified as the material of the solid electrolyte layer 130 described later.

The positive electrode active material layer may have a thickness of, for example, 5 μm or more and 300 μm or less.

The negative electrode active material layer contains a negative electrode active material. The negative electrode active material refers to a material that intercalates or deintercalates metal ions, such as lithium (Li) ions or magnesium (Mg) ions, in a crystal structure at a lower potential than the potential of the positive electrode and is accordingly oxidized or reduced. The negative electrode active material can be selected as appropriate depending on the battery type, and a known negative electrode active material can be used. The negative electrode active material can be, for example, a carbon material, such as natural graphite, artificial graphite, a graphite carbon fiber, or resin baked carbon, or an alloy-based material to be mixed with a solid electrolyte. The alloy-based material can be, for example, a lithium alloy, such as LiAl, LiZn, Li₃Bi, Li₃Cd, Li₃Sb, Li₄Si, Li_{4.4}Pb, Li_{4.4}Sn, Li_{0.17}C, or LiC₆, an oxide of lithium and a transition metal element such as lithium titanate (Li₄Ti₅O₁₂), or a metal oxide, such as zinc oxide (ZnO) or silicon oxide (SiOₓ). The negative electrode active material may be only one of these materials or a combination of two or more of the materials.

The negative electrode active material layer, which contains the negative electrode active material, may contain a different additive material. That is, the negative electrode active material layer may be a mixture layer. The additive material can be, for example, a solid electrolyte, such as a solid inorganic electrolyte or a solid sulfide electrolyte, an electrically conductive additive such as acetylene black, or a binder, such as polyethylene oxide or polyvinylidene fluoride. By mixing the negative electrode active material with the different additive material, such as a solid electrolyte or an electrically conductive additive, in a predetermined proportion, it is possible to enhance the ionic conductivity inside the negative electrode and enhance the electron conductivity inside the negative electrode as well. The solid electrolyte can be, for example, a solid electrolyte exemplified as the material of the solid electrolyte layer 130 described later.

The negative electrode active material layer may have a thickness of, for example, 5 μm or more and 300 μm or less.

The current collectors should be formed of any electrically conductive material, and are not limited to any particular material. The current collectors are each, for example, a foil-like, plate-like, or mesh-like current collector formed of, for example, stainless steel, nickel, aluminum, iron, titanium, copper, palladium, gold, or platinum, or an alloy of two or more of these metals. The material of the current collectors should be selected as appropriate in view of: neither melting nor decomposition in the manufacturing process, at the operating temperature, and at the operating pressure; the battery operation potential applied to the current collectors; and the electrical conductivity. Moreover, the material of the current collectors can be selected also depending on the required tensile strength and heat resistance. The current collectors each may be a high-strength electrolytic copper foil or a cladding material composed of laminated dissimilar metal foils.

The current collectors each may have a thickness of, for example, 10 μm or more and 100 μm or less.

The solid electrolyte layer 130 is positioned between the first electrode 120 and the second electrode 140. The solid electrolyte layer 130 may be in contact with the lower surface of the first electrode 120 and the upper surface of the second electrode 140. That is, no other layer may be provided between the solid electrolyte layer 130 and each of the electrodes.

The solid electrolyte layer 130 may not be in contact with the lower surface of the first electrode 120 and the upper surface of the second electrode 140.

The solid electrolyte layer 130 may be in contact with the respective side surfaces of the first electrode 120 and the second electrode 140, the lower surface of the first electrode 120, and the upper surface of the second electrode 140 so as to coat the respective side surfaces of the first electrode 120 and the second electrode 140.

The solid electrolyte layer 130 contains a solid electrolyte. The solid electrolyte layer 130 should contain any known ionic conductive solid electrolyte for batteries. For example, a solid electrolyte that conducts metal ions, such as lithium ions and magnesium ions, can be used. The solid electrolyte should be selected as appropriate depending on the conductive ionic species. For example, a solid inorganic electrolyte, such as a solid sulfide electrolyte or a solid oxide electrolyte, can be used. Examples of the solid sulfide electrolyte include lithium-containing sulfides, such as those based on Li₂S—P₂S₅, Li₂S—SiS₂, Li₂S—B₂S₃, Li₂S—GeS₂, Li₂S—SiS₂—Lil, Li₂S—SiS₂—Li₃PO₄, Li₂S—Ge₂S₂, Li₂S—GeS₂—P₂S₅, and Li₂S—GeS₂—ZnS. Examples of the solid oxide electrolyte include a lithium-containing metal oxide, such as Li₂O—SiO₂ and Li₂O—SiO₂—P₂O₅, a lithium-containing metal nitride such as LiₓP_{y}O_{1-z}N_{z} (0<z≤1), lithium phosphate (Li₃PO₄), and a lithium-containing transition metal oxide such as lithium titanium oxide. The solid electrolyte may be only one of these materials or a combination of two or more of the materials.

The solid electrolyte layer 130, which contains the solid electrolyte, may contain, for example, a binder, such as polyethylene oxide or polyvinylidene fluoride.

The solid electrolyte layer 130 may have a thickness of, for example, 5 μm or more and 150 μm or less.

The solid electrolyte layer 130 may be constituted of an aggregate of particles of the solid electrolyte. The solid electrolyte layer 130 may be constituted of a sintered structure of the solid electrolyte.

### (Lead Terminal 400)

The lead terminal 400 is electrically connected to the current collectors included in the electrodes. The lead terminal 400 may, for example, be in contact with the principal surfaces of the current collectors. For example, the lead terminal 400a may be in contact with the principal surface of the first current collector 110, and the lead terminal 400b may be in contact with the principal surface of the second current collector 150. To connect the lead terminal 400 to the current collectors, a highly electrically conductive adhesive containing electrically conductive metal particles such as Ag particles, solder, or the like may be used. Alternatively, various known electrically conductive resins containing Cu, Al, or the like, or electrically conductive materials containing gold-tin or other solder may be used.

The lead terminal 400 may be bent. In the case where the lead terminal 400 is bent, it is possible to suppress penetration of air and moisture into the battery 1100 through a gap between the lead terminal 400 and the second insulating member 300.

The lead terminal 400a connected to the principal surface of the first current collector 110 may extend along the principal surface of the first current collector 110 of the battery element 100 and then be bent toward a direction along the side surface of the battery element 100. The lead terminal 400b connected to the principal surface of the second current collector 150 may extend along the principal surface of the second current collector 150 of the battery element 100 and then be bent toward the direction along the side surface of the battery element 100. In this way, the lead terminal 400 may be bent toward a direction along the first insulating member 200 coating the side surface of the battery element 100. That is, the lead terminal 400 may have a portion along the side surface of the battery element 100, where the side surface is coated with the first insulating member 200.

The lead terminal 400a connected to the principal surface of the first current collector 110 may have a crank-shaped bent portion 401a. The bent portion 401a extends along the principal surface of the first current collector 110 of the battery element 100, and then is bent toward the direction along the side surface of the battery element 100 and is bent to extend toward the outside of the second insulating member 300. The lead terminal 400b connected to the principal surface of the second current collector 150 may have a crank-shaped bent portion 401b. The bent portion 401b extends along the principal surface of the second current collector 150 of the battery element 100, and then is bent toward the direction along the side surface of the battery element 100 and is bent to extend toward the outside of the second insulating member 300. The bent portion 401a and the bent portion 401b are also hereinafter collectively referred to as a bent portion 401.

The void 500 may include a void positioned between the side surface of the battery element 100 and the bent portion 401.

The portion of the lead terminal 400 may be exposed on the surface of the battery 1100. The exposed portion of the lead terminal 400, on the surface of the battery 1100, may be disposed along the side surface of the battery 1100 and furthermore bent inward again on the bottom surface of the battery 1100 so that the exposed portion of the lead terminal 400 constitutes a joining portion for the mounting board with solder or the like. In this case, the portion of the lead terminal 400 serves as the mounting terminal.

The portion, which serves as the mounting terminal, of the lead terminal 400 may have a surface containing a solder component. For example, the surface may be coated by Sn plating, with a Sn-based solder paste, or by dip coating. For example, the surface may be coated so that the resulting layer has a thickness of 1 μm or more and 10 μm or less. In this case, it is possible to adopt the reflow as a general mounting method for industrial use, thereby enhancing the productivity in mounting on boards. Moreover, the solder wettability of the mounting terminal surface is enhanced, and accordingly the fixing properties between the board and the mounting terminal are enhanced, and the reliability in practical use is enhanced as well.

The material of the lead terminal 400 can be general stainless steel (SUS) or phosphor bronze. Any electrical conductor, such as stainless steel, iron, or copper, should be used, and an alloy or a cladding material can be used as well. In view of assembling and processing efficiency, mounting efficiency, durability to vibration or the thermal cycling test, etc., other conductor may be used as appropriate depending on the application.

The width of the lead terminal 400 may be adjusted as appropriate according to the size of the battery element 100, the land pattern of the mounting board, etc. The width of the lead terminal 400 may be smaller than the width of the battery element 100. In the case where the width of the lead terminal 400 is smaller than the width of the battery element 100, the outer periphery of the battery element 100 can be used as positioning for the lead terminal 400. Moreover, a reduction in heat capacity of the lead terminal 400 can enhance the productivity in the heat treatment process.

The lead terminal 400 may have a thickness of 200 μm or more and 1000 μm or less.

To support the high electric current or to enhance the fixing strength, the lead terminal 400 may be further increased in width, and may be further increased in thickness.

The lead terminal 400 may have a through hole. In this case, the anchor effect between the second insulating member 300 and the lead terminal 400 is enhanced, so that the impact resistance and the reliability in repetition of charge and discharge are enhanced. Furthermore, in the case where the lead terminal 400 has a through hole, the heat capacity can be reduced, so that the solder wettability during solder mounting is enhanced and high fixing strength is achieved accordingly. Moreover, the influence of the stress acting on the surroundings due to thermal expansion of the battery element 100 can be reduced, so that an action and an effect of suppressing a structural defect of the battery is achieved as well.

In the case where the lead terminal 400 has the above crank-shaped bent portion 401, the through hole may be provided in the bent portion 401 of the lead terminal 400.

The through hole is not limited to any particular shape. The through hole may have a circular shape or a rectangular shape. In this case, it is possible to enhance the anchor effect between the lead terminal 400 and the second insulating member 300.

The number of the through holes may be one, or may be more than one. The number of the through holes should be within a range by which any problem in assembling, strength, etc. is not caused.

The through hole is formed, for example, by punching the lead terminal 400 with a die or by etching.

The through hole may enclose a void. By enclosing a void in the through hole, it is possible to further increase the stress absorbency and high fixing reliability exhibited by the through hole. Therefore, a highly reliable battery is achieved.

The corner portions (ridge lines) of the lead terminal 400 may be chamfered. In this case, the occurrence of cracks in the second insulating member 300 originating from the corner portions (ridge lines) of the lead terminal 400 due to the thermal cycle or the stress of impact is suppressed. Consequently, the reliability is further enhanced. The chamfering may be performed, for example, by sandblasting or polishing. The extent of the chamfering may be 5 μm or more and 100 μm or less for the round shape.

The battery 1100 according to Embodiment 1 may further include a water-repellent material, and the water-repellent material may be in contact with the lead terminal 400.

### (Void 500)

The void 500 acts as an absorber for the stress acting on the battery 1100, such as, expansion and contraction of the battery element 100 resulting from charge and discharge or flexural stress. The void 500 includes a void positioned close to the side surface of the battery element 100.

The void 500 may be positioned between the side surface of the battery element 100 and the lead terminal 400.

According to the above configuration, it is possible to further absorb expansion and contraction during operations of the battery element 100 or the stress during the mounting, and also to absorb deformation and thermal expansion of the lead terminal 400. Consequently, the stress on the second insulating member 300 can be relieved, and a structural defect can be suppressed accordingly.

Here, the phrase “the void 500 is positioned between the side surface of the battery element 100 and the lead terminal 400” means that the void 500 is present at a position overlapping with the lead terminal 400 inside the second insulating member 300 when the battery 1100 is viewed from the side surface.

For example, the lead terminal 400 may include a portion parallel to the side surface of the battery element 100 so that the void 500 is positioned between the portion and the side surface of the battery element 100.

The void 500 may be positioned between the side surface of the battery element 100 and the lead terminal 400, where the side surface is coated with the first insulating member 200.

Here, the phrase “the void 500 is positioned between the side surface of the battery element 100 and the lead terminal 400, where the side surface is coated with the first insulating member 200” means that, the void 500 is present at a position overlapping with the lead terminal 400 inside the second insulating member 300 and the side surface of the battery element 100 when the battery 1100 is viewed from the side surface, where the side surface is coated with the first insulating member 200.

The void 500 may be in contact with the first insulating member 200. In this case, the void 500 functions as a space that more effectively absorbs expansion and contraction of the battery element 100. Consequently, the stress on the second insulating member 300 can be relieved, and a structural defect of the battery 1100, such as breakage or cracking, can be suppressed accordingly.

As shown in FIG. 1, in the case where the battery 1100 includes the two lead terminals 400a and 400b and the two lead terminals 400a and 400b include respective portions parallel to the two opposing side surfaces of the battery element 100, the void 500 may be positioned between one lead terminal (e.g., the lead terminal 400a) and the battery element 100, and the void 500 may also be positioned between the other lead terminal (e.g., the lead terminal 400b) and the battery element 100. In the case where the void 500 is positioned between the lead terminal 400a and the battery element 100 and is positioned between the lead terminal 400b and the battery element 100, the voids 500 do not need to be symmetrical in terms of form or number.

The void 500 may be in contact with the side surface of the battery element 100. In this case, the void 500 functions as a space that absorbs expansion and contraction of the battery element 100. Consequently, the stress on the second insulating member 300 can be relieved, and a structural defect of the battery, such as breakage or cracking, can be suppressed accordingly.

The void 500 may be in contact with the lead terminal 400. In the vicinity of the battery element 100, the void 500 may be in contact with the lead terminal 400. In this case, the void 500 functions as a space that absorbs expansion and contraction of the battery element 100 and absorbs deformation or thermal expansion of the lead terminal 400. Consequently, the stress on the second insulating member 300 can be relieved, and a structural defect can be suppressed accordingly.

The void 500 may be in contact with the battery element 100, the first insulating member 200, and the lead terminal 400. The battery element 100 may share the void 500 with the first insulating member 200 and the lead terminal 400.

In the case where the lead terminal 400 has a through hole, the void 500 may include a void positioned inside the through hole.

The void 500 may be filled with a gas. In this case, the inside of the void 500 at high temperatures is at positive pressure, and a pressure is applied to the surroundings of the void 500 (e.g., the side surface of the battery element 100). This action can suppress the collapse of the electrode material which would be caused by the binder component in the battery element 100 becoming soft at high temperatures. Note that the collapse of the electrode material is referred to as also “powder fall”, for example. Therefore, a battery having enhanced reliability in a relatively high-temperature domain is achieved. Furthermore, owing to the elastic action of the gas component inside the void 500, elastic deformation and the repulsive performance surrounding the void 500 can be controlled, so that the stress absorbency can be adjusted. Owing to such an action, a battery that is excellent in repetition of charge and discharge and impact resistance is achieved. The gas should be any gas that has no adverse influence on the characteristics of the battery element 100 and the first insulating member 200 and the second insulating member 300. Examples of the gas include air, nitrogen gas, and argon gas.

The void 500 is not limited to any particular shape. The void 500 may have a shape including neither a corner portion (particularly, an acute-angled portion and a sharp portion) nor a long-distance linear side. That is, the void 500 may have a shape defined by a curved surface. In this case, it is possible to achieve high limit performance of the battery. A void having a shape with corner portions, such as a cube or a tetrahedron is prone to stress concentration, and accordingly is likely to become the origin of fracture as a result of a high stress. In particular, in the case where the corner portions include an acute angle rather than an obtuse angle on the inner wall of the void, the void is likely to become the origin of fracture. Moreover, for the same reason as a void including a shape with corner portions, a void including a long-distance linear side (e.g., several tens of μm or more) is also likely to become the origin of fracture as a result of a high stress. From the viewpoint of suppressing local stress concentration, the inner wall of the void 500 may be a free surface that remains cured (a glossy surface without unevenness).

The void 500 may be a closed pore. In this case, it is possible to repeatedly absorb impact and displacement by elastic deformation of the second insulating member 300 while maintaining the sealing properties of the battery element 100.

It is more preferable that the closed pore should have a wall surface especially in the shape with no corners, unlike a rectangle and the like, that is, in the shape of a sphere, an ellipse, or the like. In this case, it is possible to suppress damage to the void 500 due to local stress concentration on the void 500 (e.g., stress concentration on the corner portions of the void 500) caused by expansion and contraction of the battery element 100 resulting from charge and discharge, the flexural stress acting on the battery, etc. Consequently, the limit performance of the battery and the reliability in repetition of charge and discharge are enhanced.

The void 500 may be in the form of a plurality of holes that communicate with each other to be continuous. The void 500 may be a hole deformed from a sphere or an ellipse. The void 500 may be a communication hole that is a closed pore.

The void 500 may contain the volatile component of a solvent emitted from the battery element 100. In this case, the same effect as the effect in the case where the void 500 contains a gas such as air is achieved. For example, by leaving a portion of a solvent during applying and drying in the battery manufacturing, a thermal process during assembling (e.g., the curing process for the insulating member) enables enclosure of the volatile component of the solvent.

The void 500 is not limited to any particular size. The void 500 may have, for example, a diameter of 10 μm or more and 1000 μm or less for a spherical shape.

The number of the voids 500 may be one, or may be more than one.

The void 500 can be confirmed by a cross-sectional observation method with an ordinary optical microscope or scanning electron microscope (SEM). The void 500 can be observed also by non-destructive analysis such as computed tomography (CT) scanning. Moreover, whether the void 500 is a closed pore can be determined by checking, for example, through liquid immersion aging or vacuum suction, whether penetration into the internal structure has occurred.

### (First Insulating Member 200 and Second Insulating Member 300)

The first insulating member 200 coats at least a portion of the side surface of the battery element 100.

Consequently, it is possible to suppress characteristics degradation of the battery, which is due to fall-off of the active material powder, that is, powder fall from the side surface of the battery element 100.

The first insulating member 200 may coat the side surface of the battery element 100, where the side surface is adjacent to the lead terminal 400. In this case, it is possible to suppress characteristics degradation and a short circuit between the battery element 100 and the lead terminal 400, which are due to fall-off of the active material powder from the side surface of the battery element 100. Moreover, it is also possible to prevent the lead terminal 400 and the battery element 100 from coming into contact with each other and thus causing a short circuit during assembling.

The first insulating member 200 should be formed of any insulating material that has no influence on the battery characteristics. The first insulating member 200 may be, for example, a thermosetting epoxy resin.

The first insulating member 200 should have a thickness with which electrical insulation is achieved. The first insulating member 200 may have a thickness of, for example, 3 μm or more and 90 μm or less. The first insulating member 200 may have a thickness of 3 μm or more and 10 μm or less, or may have a thickness of 30 μm or more and 90 μm or less.

The size of the first insulating member 200 should be set within a range by which a decrease in capacity density is not caused. For example, the electrodes and the end surfaces of the current collectors of the battery element 100 may be at least partially coated with the first insulating member 200. In this case, separation of the current collectors is suppressed.

The second insulating member 300 is an exterior material that houses the battery element 100. The second insulating member 300 encloses the battery element 100, the first insulating member 200, and the void 500.

The proportion of the voids 500 (porosity) in the second insulating member 300 may be 0.1 volume % or more and 5 volume % or less, 0.1 volume % or more and 1 volume % or less, or 0.1 volume % or more and 0.5 volume % or less. The proportion of the voids 500 in the second insulating member 300 may be 0.5 volume % or more and 5 volume % or less, or 0.5 volume % or more and 1 volume % or less. The proportion of the voids 500 in the second insulating member 300 may be 1 volume % or more and 5 volume % or less.

The proportion of the voids 500 in the second insulating member 300 can be determined, for example, by performing observation with an ordinary optical microscope or scanning electron microscope (SEM) on the polished cross section of the second insulating member 300 obtained through mechanical polishing, ion polishing, or the like, and determining the area of the voids.

The second insulating member 300 should be formed of any insulating material that has no influence on the battery characteristics.

The second insulating member 300 is, for example, a member formed of a molded resin. The second insulating member 300 may be a member that seals, with a molded resin, the battery element 100, the first insulating member 200, and the void 500.

The material of the first insulating member 200 and the second insulating member 300 should be any electrical insulator. The material of the first insulating member 200 and the second insulating member 300 may include a resin. Examples of the resin include an epoxy resin, an acrylic resin, a polyimide resin, and silsesquioxane. The material of the first insulating member 200 and the second insulating member 300 may be, for example, an applicable resin such as a liquid or powder thermosetting epoxy resin. Such an applicable resin in a liquid or powder state is applied onto the side surface of the battery element 100 or applied as the exterior body of the battery 1100 for thermal curing, so that integral formation of a miniature battery can be achieved. Thus, the reliability of the battery can be enhanced.

The second insulating member 300 may include a thermosetting epoxy resin. The second insulating member 300 may be formed of a thermosetting epoxy resin.

The first insulating member 200 and the second insulating member 300 each may be formed of a different material. In this case, owing to the combinations of different insulating materials and the void, it is possible to achieve various stress absorbencies with respect to expansion and contraction of the battery element 100 and deformation of the lead terminal 400. Consequently, the reliability of the battery can be enhanced.

The first insulating member 200 may be harder than the second insulating member 300. In this case, while the battery element 100 is protected, the stress caused by expansion and contraction of the battery element 100 resulting from charge and discharge and deformation of the lead terminal 400 is absorbed by the shock absorbing properties of the second insulating member 300, thereby suppressing internal cracking. Consequently, the operating life of the battery is prolonged. Therefore, the battery according to Embodiment 1 has high charge and discharge cycle performance, high deflection resistance performance, and high impact resistance performance. That is, the battery according to Embodiment 1 has enhanced reliability. In the case where the second insulating member 300 is harder than the first insulating member 200, the stress and strain concentrate on the first insulating member 200, which has a smaller volume ratio and is softer. This sometimes causes a structural defect such as separation of the first insulating member 200 from the side surface of the battery element 100.

The first insulating member 200 and the second insulating member 300 may be softer than any constituent member of the battery element 100, specifically, the first current collector 110, the first electrode 120, the solid electrolyte layer 130, the second electrode 140, and the second current collector 150. In this case, the first insulating member 200 and the second insulating member 300, which are relatively soft, can absorb the stress generated between the constituent members of the battery 1100. Consequently, it is possible to suppress a structural defect of the battery 1100, such as cracking or separation.

The first insulating member 200 and the second insulating member 300 each may have a Young's modulus of, for example, 10 GPa or more and 40 GPa or less. For example, an epoxy resin having a Young's modulus in such a range may be used for the first insulating member 200 and the second insulating member 300. In this case, it is possible to enhance the reliability of the battery 1100.

The first insulating member 200 and the second insulating member 300 each may include an epoxy resin.

The first insulating member 200 and the second insulating member 300 may be formed of the same material. In this case, it is also possible to increase the efficiency in manufacturing control, thereby enhancing mass productivity. The first insulating member 200 and the second insulating member 300 each may be formed of an epoxy resin. In this case, it is possible to achieve a miniature and highly reliable battery.

In the case where the first insulating member 200 and the second insulating member 300 are formed of the same material, the boundary between the first insulating member 200 and the second insulating member 300 can be confirmed by a cross-sectional observation method with an ordinary optical microscope or scanning electron microscope (SEM).

Even in the case where the same thermosetting epoxy resin is used for the first insulating member 200 and the second insulating member 300, the hardness (extent of curing) can be adjusted by adjusting the curing temperature and the curing time. For example, by performing an increase in curing temperature, an extension in curing time, or an increase in number of times of the curing process on the first insulating member 200 as compared with the second insulating member 300, it is possible to increase the hardness of the first insulating member 200 to be higher than the hardness of the second insulating member 300.

It is possible to make a comparison on the relative relation in softness (e.g., elastic modulus such as Young's modulus) between the constituent members of the battery element 100, the first insulating member 200, and the second insulating member 300, by applying a rigid indenter and comparing the magnitude relation in size of the indentation between the constituent members of the battery element 100, the first insulating member 200, and the second insulating member 300 as in the Vickers hardness measurement. For example, the indenter is pressed against portions of the cross section of the battery 1100 with the same force. In the case where the second insulating member 300 becomes recessed more greatly than any constituent member of the battery element 100, the second insulating member 300 is softer than any constituent member of the battery element 100.

At least one selected from the group consisting of the first insulating member 200 and the second insulating member 300 may be a laminated film.

Modifications of the battery 1100 according to Embodiment 1 will be described below. The matters described in Embodiment 1 can be omitted.

### Embodiment 2

A battery according to Embodiment 2 will be described below.

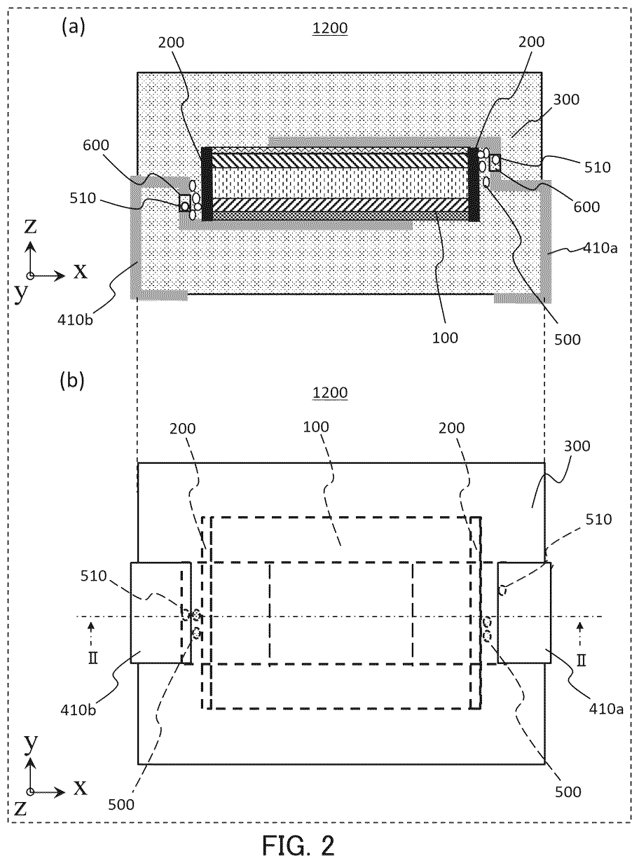

FIG. 2 schematically shows the configuration of a battery 1200 according to Embodiment 2. FIG. 2(a) is a schematic cross-sectional view showing the configuration of the battery 1200 according to Embodiment 2 as viewed in the y-axis direction. FIG. 2(b) is a schematic plan view showing the configuration of the battery 1200 according to Embodiment 2 as viewed from below in the z-axis direction. In FIG. 2(a), a cross section at the position indicated by line II-II in FIG. 2(b) is shown.

The battery 1200 includes, instead of the lead terminal 400 of the battery 1100, a lead terminal 410a electrically connected to the first current collector 110 and a lead terminal 410b electrically connected to the second current collector 150. The lead terminal 410a and the lead terminal 410b are also hereinafter collectively referred to as a lead terminal 410. The lead terminal 410 has a through hole 600. In the battery 1200, the void 500 is present close to the side surface of the battery element 100, and a void 510 is present inside the through hole 600.

The above configuration enhances the anchor effect between the lead terminal 410 and the second insulating member 300 and the sealing properties of the lead terminal 410 in the second insulating member 300. Moreover, the thermal expansion coefficient of the lead terminal 410 and the absorption performance for flexural stress are enhanced. Therefore, the battery 1200 according to Embodiment 2 has enhanced reliability.

The through hole 600 may be adjacent to the battery element 100.

### Embodiment 3

A battery according to Embodiment 3 will be described below.

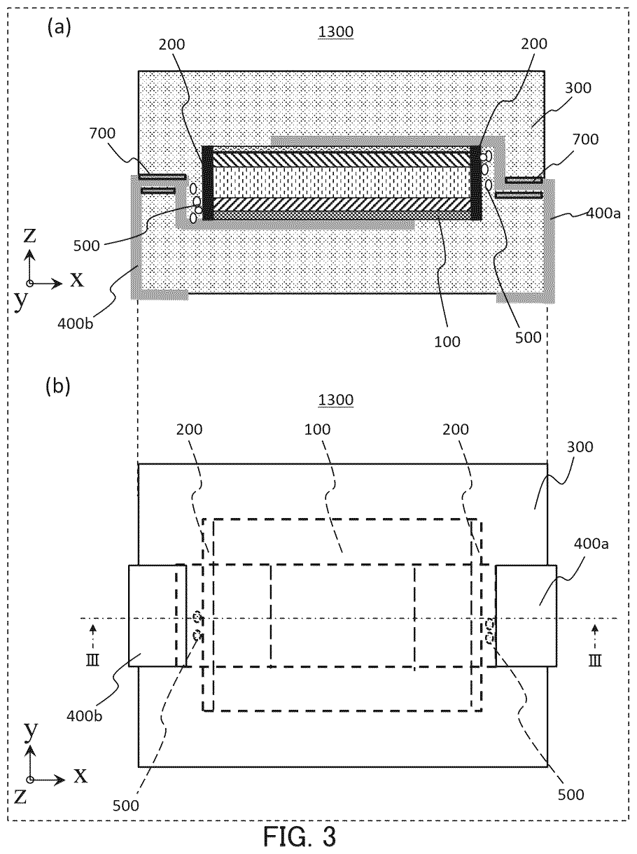

FIG. 3 schematically shows the configuration of a battery 1300 according to Embodiment 3. FIG. 3(a) is a schematic cross-sectional view showing the configuration of the battery 1300 according to Embodiment 3 as viewed in the y-axis direction. FIG. 3(b) is a schematic plan view showing the configuration of the battery 1300 according to Embodiment 3 as viewed from below in the z-axis direction. In FIG. 3(a), a cross section at the position indicated by line III-III in FIG. 3(b) is shown.

The battery 1300 includes a sealing material 700 in addition to the constituent elements of the battery 1100. The sealing material 700 is positioned between the second insulating member 300 and the lead terminal 400.

According to the above configuration, a gap at the interface between the second insulating member 300 and the lead terminal 400 generated by expansion and contraction or deflection of the battery element 100 can be sealed in conformity with elastic deformation of the sealing material 700. As a result, it is possible to prevent penetration of the outside air and moisture into the battery 1300. Therefore, the battery 1300 according to Embodiment 3 has enhanced reliability.

Filling with the sealing material 700 can be performed, for example, by applying a silicone-based or other sealing material with a dispenser onto the surroundings of the exposed portion of the lead terminal 400 exposed from the second insulating member 300 and performing vacuum suction and thus to inject the sealing material deep into the second insulating member 300, which is the exterior material of the battery (e.g., into the battery element 100). According to such a method, the sealing material can be injected into even, for example, a gap of 1 μm to 100 μm. The filling sealing material is cured, and thus the sealing material 700 can be obtained. The vacuum suction may be repeatedly performed. After the curing, the sealing material may be again subjected to repetitive vacuum suctions for injection. In this case, it is also possible to increase the integrity of the seal.

The sealing material 700 to be used is a known sealing material such as one based on silicone, polysulfide, acrylic urethane, polyurethane, acrylic, or butyl rubber.

The battery 1300 may include a silane coupling agent in addition to the sealing material 700. The silane coupling agent may be positioned at the interface between the second insulating member 300 and the lead terminal 400, as well as the sealing material 700 is. In this case, a water-repellent effect is achieved.

The silane coupling agent may be applied onto the lead terminal 400 in advance for assembly. The silane coupling agent is effective especially for suppressing moisture penetration into the battery through a minute gap of 1 μm or less.

The silane coupling agent should be any general one. For example, a known silane coupling agent can be used, such as one based on methoxy, ethoxy, dialkoxy, or trialkoxy. The silane coupling agent should be any one exhibiting a water-repellent effect on the surfaces of the lead terminal 400 to be used and the second insulating member 300.

### Embodiment 4

A battery according to Embodiment 4 will be described below.

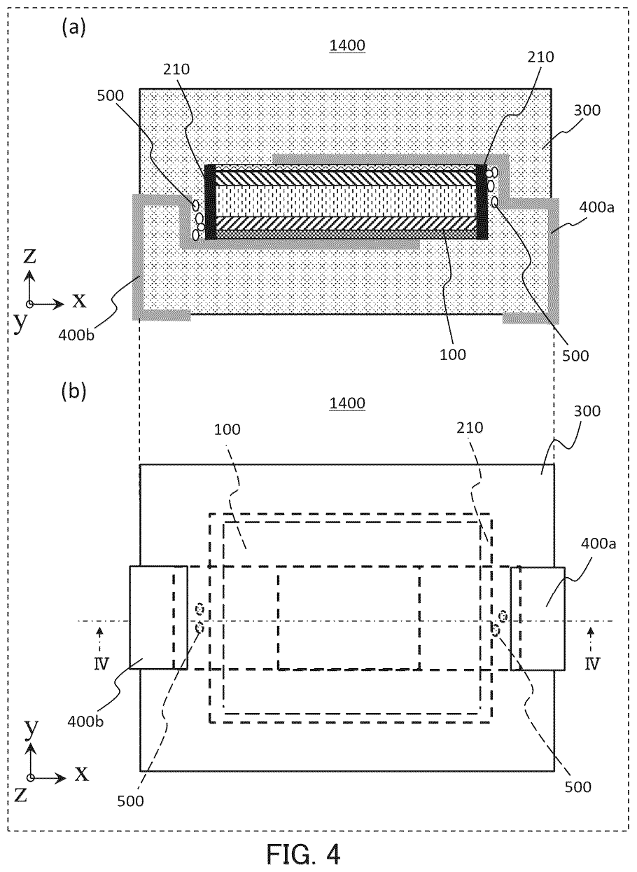

FIG. 4 schematically shows the configuration of a battery 1400 according to Embodiment 4. FIG. 4(a) is a schematic cross-sectional view showing the configuration of the battery 1400 according to Embodiment 4 as viewed in the y-axis direction. FIG. 4(b) is a schematic plan view showing the configuration of the battery 1400 according to Embodiment 4 as viewed from below in the z-axis direction. In FIG. 4(a), a cross section at the position indicated by line IV-IV in FIG. 4(b) is shown.

As shown in FIG. 4, in the battery 1400, a first insulating member 210 coats the entire side surface of the battery element 100.

According to the above configuration, powder fall on the side surface of the battery element 100 is further suppressed, so that characteristics degradation and a short circuit are suppressed further easily. Therefore, the battery 1400 according to Embodiment 4 has enhanced reliability.

### Embodiment 5

A battery according to Embodiment 5 will be described below.

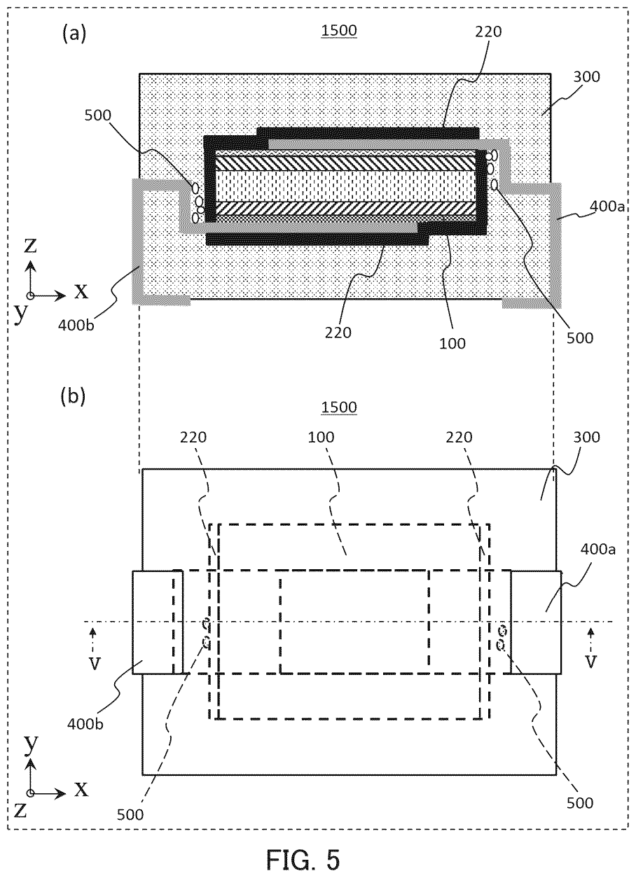

FIG. 5 schematically shows the configuration of a battery 1500 according to Embodiment 5. FIG. 5(a) is a schematic cross-sectional view showing the configuration of the battery 1500 according to Embodiment 5 as viewed in the y-axis direction. FIG. 5(b) is a schematic plan view showing the configuration of the battery 1500 according to Embodiment 5 as viewed from below in the z-axis direction. In FIG. 5(a), a cross section at the position indicated by line V-V in FIG. 5(b) is shown.

As shown in FIG. 5, in the battery 1500, a first insulating member 220 coats not only a portion of the side surface of the battery element 100 but also a portion of the upper and lower principal surfaces of the battery element 100 and a portion of the lead terminal 400.

According to the above configuration, it is possible to enhance the fixing strength of the lead terminal 400. As a result, it is possible to prevent coming off of the lead terminal 400 due to the thermal cycle or impact. Therefore, the battery 1500 according to Embodiment 5 has enhanced reliability.

### Embodiment 6

A battery according to Embodiment 6 will be described below.

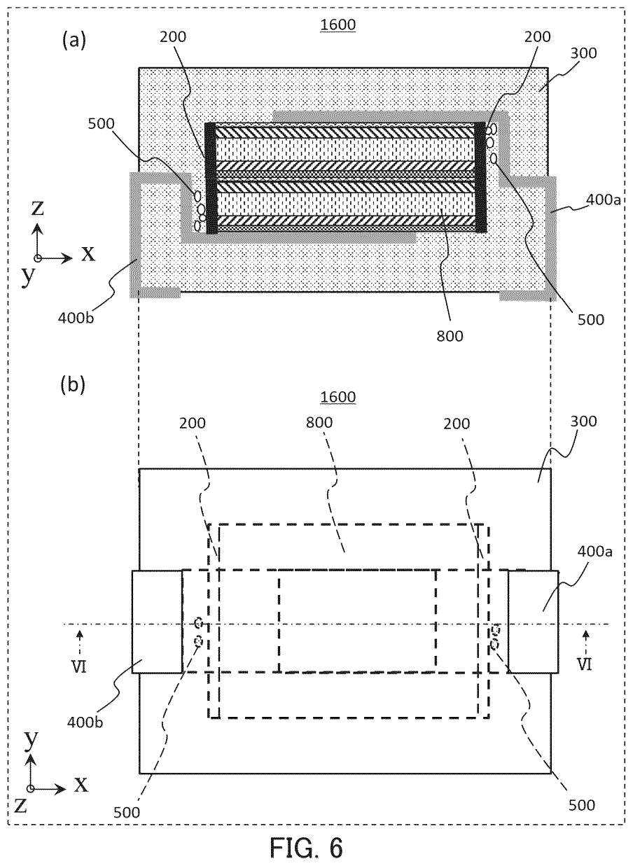

FIG. 6 schematically shows the configuration of a battery 1600 according to Embodiment 6. FIG. 6(a) is a schematic cross-sectional view showing the configuration of the battery 1600 according to Embodiment 6 as viewed in the y-axis direction. FIG. 6(b) is a schematic plan view showing the configuration of the battery 1600 according to Embodiment 6 as viewed from below in the z-axis direction. In FIG. 6(a), a cross section at the position indicated by line VI-VI in FIG. 6(b) is shown.

As shown in FIG. 6, the battery 1600 includes a battery element 800. The battery element 800 includes the plurality of battery elements 100 that are laminated.

The plurality of battery elements 100 include the opposing electrodes that are electrically connected to each other. This constitutes a bipolar electrode in the battery 1600.

According to the above configuration, the battery 1600 according to Embodiment 6 has a high operating voltage and a high energy density.

The plurality of battery elements 100 are, for example, adhered to each other with an electrically conductive adhesive or the like.

The electrically conductive adhesive may be a thermosetting electrically conductive paste. The thermosetting electrically conductive paste is, for example, a thermosetting electrically conductive paste containing silver metal particles. The resin to be used for the thermosetting electrically conductive paste should be any resin functioning as the binder. Furthermore, an appropriate resin with suitable printing performance, application performance, or the like may be selected depending on the manufacturing process to be employed. The resin to be used for the thermosetting electrically conductive paste includes, for example, a thermosetting resin. Examples of the thermosetting resin include (i) an amino resin, such as urea resin, melamine resin, and guanamine resin, (ii) an epoxy resin, such as bisphenol A epoxy resin, bisphenol F epoxy resin, phenol novolac epoxy resin, and alicyclic epoxy resin, (iii) an oxetane resin, (iv) a phenolic resin, such as resol phenolic resin and novolac phenolic resin, and (v) a silicone-modified organic resin, such as silicone epoxy resin and silicone polyester resin. The resin may be only one of these materials or a combination of two or more of the materials.

The battery element 800 may include the two battery elements 100 that are laminated in series in the z-axis direction. Alternatively, the battery element 800 may include the three or more battery elements 100 that are laminated.

The plurality of battery elements 100 may be laminated so as to be electrically connected in parallel. In this case, a laminated battery having a high capacity and enhanced reliability can be achieved.

### [Method for Manufacturing Battery]

A method for manufacturing the battery of the present disclosure will be described. A method for manufacturing the battery 1600 according to Embodiment 6 will be described below as an example.

In the following description of the manufacturing method, the first electrode 120 is the positive electrode, and the second electrode 140 is the negative electrode. Accordingly, the first current collector 110 is the positive electrode current collector, and the second current collector 150 is the negative electrode current collector. The battery element 800 includes the two battery elements 100 that are laminated in series.

First, pastes are produced that are to be used for forming the first active material layer 160 (hereinafter, referred to as a positive electrode active material layer) and the second active material layer 170 (hereinafter, referred to as a negative electrode active material layer) by printing. A solid electrolyte raw material to be prepared for use as a mixture of each of the positive electrode active material layer and the negative electrode active material layer is, for example, a Li₂S—P₂S₅-based sulfide glass powder having an average particle diameter of about 10 μm and containing triclinic crystals as its main component. The glass powder has a high ionic conductivity in, for example, an approximate range of 2×10⁻³ S/cm to 3×10⁻³ S/cm. The positive electrode active material to be used is, for example, a Li⋅Ni⋅Co⋅Al composite oxide (e.g., LiNi_{0.8}Co_{0.15}Al_{0.05}O₂) powder having an average particle diameter of about 5 μm and a layered structure. A mixture containing the above positive electrode active material and the above glass powder is dispersed in an organic solvent or the like to produce a positive electrode active material layer paste. The negative electrode active material to be used is, for example, a natural graphite powder having an average particle diameter of about 10 μm. A mixture containing the above negative electrode active material and the above glass powder is dispersed in an organic solvent or the like to produce a negative electrode active material layer paste in the similar manner.

Subsequently, the first current collector 110 (hereinafter, referred to as a positive electrode current collector) and the second current collector 150 (hereinafter, referred to as a negative electrode current collector) to be prepared are each, for example, a copper foil having a thickness of about 15 μm. The above positive electrode active material layer paste and negative electrode active material layer paste are each printed on one surface of the copper foil, for example, by screen printing, so as to have a predetermined shape and a thickness in an approximate range of 50 μm to 100 μm. The positive electrode active material layer paste and the negative electrode active material layer paste are dried at 80° C. or more and 130° C. or less. Thus, the positive electrode active material layer is formed on the positive electrode current collector, and the negative electrode active material layer is formed on the negative electrode current collector. The positive electrode active material layer and the negative electrode active material layer each have a thickness of, for example, 30 μm or more and 60 μm or less.

Subsequently, the above glass powder is dispersed in an organic solvent or the like to produce a solid electrolyte layer paste. The above solid electrolyte layer paste is printed on each of the positive electrode and the negative electrode with a metal mask so as to have a thickness of, for example, about 100 μm. Thereafter, the positive electrode and the negative electrode, on which the solid electrolyte layer paste has been printed, are dried at 80° C. or more and 130° C. or less.

Subsequently, the solid electrolyte printed on the positive electrode and the solid electrolyte printed on the negative electrode are laminated so as to be in contact with each other and oppose to each other.

Subsequently, the laminate thus obtained is pressurized with a press die. Specifically, an elastic sheet having a thickness of 70 μm and an elastic modulus of about 5×10⁶ Pa is inserted between the laminate and the press die plate, that is, between the upper surface of the current collector of the laminate and the press die plate. According to this configuration, a pressure is applied to the laminate through the elastic sheet. Thereafter, the laminate is pressurized for 90 seconds while the press die is heated to 50° C. at a pressure of 300 MPa. Thus, the battery element 100 is obtained.

Thereafter, as the material of the first insulating member 200, a thermosetting epoxy resin is applied onto the two side surfaces of the battery element 100 in the short direction so as to have a thickness in an approximate range of 10 μm to 30 μm, and subjected to a thermal curing process. The curing temperature is, for example, in an approximate range of 100° C. to 200° C., and the curing time is, for example, 0.5 hours or more and 2 hours or less. After the thermal curing process, the thermosetting epoxy resin is cooled to room temperature at the rate of about 50° C./min or less. The cooling at the cooling rate of 50° C./min or less makes the first insulating member 200 to be less prone to separate. Thus, the first insulating member 200 is fixed to the side surface of the battery element 100. At this time, the application and the curing of the material of the first insulating member 200 may be repeated, for example, three times so that the first insulating member 200 having a thickness in an approximate range of 30 μm to 90 μm is fixed to coat the side surface of the battery element 100. Thus, the battery element 100 whose side surface is coated with the first insulating member 200 is produced.

The above two battery elements 100 each having the side surface coated are prepared. On the surface of the negative electrode current collector of one of the battery elements 100, a thermosetting electrically conductive paste containing silver particles is printed by screen printing so as to have a thickness of about 30 μm. Then, the negative electrode current collector of the one battery element 100 and the positive electrode current collector of the other battery element 100 are disposed to be joined to each other with the electrically conductive paste, and are pressure-bonded. Thereafter, the battery elements 100 are allowed to stand with a pressure of, for example, about 1 kg/cm² applied, and subjected to a thermal curing process. The curing temperature is, for example, 100° C. or more and 300° C. or less. The curing time is, for example, 60 minutes. After the thermal curing process, the battery elements 100 are cooled to room temperature. Thus, the battery element 800 in which the two battery elements 100 are connected in series is obtained.

Subsequently, the two lead terminals 400a and 400b are prepared. The lead terminal 400 prepared is, for example, stainless steel (SUS) having a thickness of 300 μm. With a silver-based electrically conductive resin, one lead terminal 400 (e.g., the lead terminal 400a) is joined to the principal surface of the positive electrode current collector of the battery element 800, and the other lead terminal 400 (e.g., the lead terminal 400b) is joined to the principal surface of the negative electrode current collector of the battery element 800, and the resin is subjected to a thermal curing process. The curing temperature is, for example, 150° C. or more and 200° C. or less. The curing time is, for example, 1 hour or more and 2 hours or less. Thus, the lead terminal 400 is joined to the battery element 800.

The lead terminal 400 is subjected to a bending process so as to have a portion along the first insulating member 200 that coats the side surface of the battery element 800. Here, the bending process is performed so that a gap can be generated between the first insulating member 200 and the lead terminal 400. Furthermore, for example, at a position about half the thickness of the battery element 800, the lead terminal 400 is subjected to a bending process again in the outward direction of the battery element 800.

Subsequently, in a die, a thermosetting epoxy resin is put, and the battery element 800 to which the lead terminal 400 is connected is immersed at a predetermined position for housing. At this time, the proportion of the voids 500 in the epoxy resin liquid is adjusted. For example, stirring the epoxy resin enables a large amount of air to be contained as the void 500. Furthermore, the void 500 also can be formed at a desired position with a dispenser. By injecting air or a gas, for example, between the lead terminal 400 and the side surface of the battery element 800 in the epoxy resin liquid through the needle tip having a gauge, for example, in an approximate range of 100 μm to 500 μm, it is also possible to selectively form the void 500 having a diameter approximately equal to the gauge between the lead terminal 400 and the side surface of the battery element 800. Moreover, by swinging or vibrating the die, which houses the epoxy resin and the battery element 800 to which the lead terminal is connected, it is also possible to remove foam from air in the epoxy resin liquid to reduce the void 500. To inject nitrogen gas or argon gas into the void 500, the process of immersion in the epoxy resin should be performed in a desiccator or a glove box under a desired gas atmosphere. Alternatively, a desired gas should be injected into the epoxy resin with a dispenser. The surface tension of the epoxy resin stabilizes the void 500 to have the minimum volume and have a shape with an inner wall defined by a spherical bent surface having no corner portions. Thereafter, the epoxy resin is subjected to a thermal curing process. The curing temperature is, for example, 180° C. or more and 230° C. or less. The curing time is, for example, 1 hour or more and 2 hours or less. After the curing, an exposed portion of the lead terminal 400, exposed from the epoxy resin, which is the second insulating member 300, is subjected to a bending process to serve as the mounting terminal portion of the battery. Thus, the battery 1600 is obtained.

The method and order of forming the battery are not limited to the above examples.

The above manufacturing method shows the example in which, in manufacturing the battery element 100 and the battery element 800, screen printing is used to apply the positive electrode active material layer paste, the negative electrode active material layer paste, the solid electrolyte layer paste, and the electrically conductive paste. However, the printing method is not limited to this. The printing method may be, for example, a doctor blade method, a calendering method, a spin coating method, a dip coating method, an inkjet method, an offset method, a die coating method, or a spray method.

While the battery of the present disclosure has been described on the basis of the embodiments, the present disclosure is not limited to the embodiments. Various modifications of the embodiments conceivable by those skilled in the art and other embodiments achieved by combining some of the constituent elements of the embodiments and the modifications also fall within the scope of the present disclosure without departing from the spirit of the present disclosure.

### INDUSTRIAL APPLICABILITY

The battery according to the present disclosure can be used, for example, as a secondary battery such as an all-solid-state battery for use in various electronic devices, automobiles, and the like.

What is claimed is:

1. A battery comprising:
a battery element, the battery element including a first electrode, a solid electrolyte layer, and a second electrode;
a first insulating member;
a second insulating member; and
a void, wherein
the battery element has a laminated structure in which the first electrode, the solid electrolyte layer, and the second electrode are disposed in this order,
the first insulating member coats at least a portion of a side surface of the battery element,
the second insulating member encloses the battery element, the first insulating member, and the void, and
the void includes a void positioned close to the side surface of the battery element.

2. The battery according to claim 1, further comprising
a lead terminal connected to the first electrode or the second electrode.

3. The battery according to claim 2, wherein
the void includes a void positioned between the side surface of the battery element and the lead terminal.

4. The battery according to claim 3, wherein
the lead terminal is connected to a principal surface of the first electrode or a principal surface of the second electrode,
the lead terminal has a crank-shaped bent portion, the bent portion being bent from the principal surface of the first electrode or the principal surface of the second electrode toward a direction along the side surface of the battery element and being bent to extend toward an outside of the second insulating member, and
the void includes a void positioned between the side surface of the battery element and the bent portion.

5. The battery according to claim 2, wherein
the lead terminal has a through hole.

6. The battery according to claim 5, wherein
the void includes a void positioned inside the through hole.

7. The battery according to claim 2, further comprising
a sealing material, wherein
the sealing material is positioned between the second insulating member and the lead terminal.

8. The battery according to claim 2, further comprising
a water-repellent material, wherein
the water-repellent material is in contact with the lead terminal.

9. The battery according to claim 1, wherein
the void is a closed pore.

10. The battery according to claim 1, wherein
the void is in contact with the first insulating member.

11. The battery according to claim 1, wherein
the void is filled with a gas.

12. The battery according to claim 1, wherein
the first insulating member and the second insulating member each include an epoxy resin.

13. The battery according to claim 1, wherein
the first insulating member and the second insulating member are each formed of a different material.

14. The battery according to claim 1, wherein
the first insulating member is harder than the second insulating member.

15. The battery according to claim 1, wherein
the first insulating member is a laminated film.

16. The battery according to claim 1, wherein
the second insulating member is a laminated film.
